(19) United States
(12) Patent Application Publication
(10) Pub. No.: US 2016/0169542 A1
(43) Pub. Date: Jun. 16, 2016

(54) AIR WASHER

(71) Applicant: WINIX INC., Gyeonggi-do (KR)

(72) Inventor: Hee Jong YOON, Seoul (KR)

(21) Appl. No.: 14/909,702

(22) PCT Filed: Aug. 1, 2014
(86) PCT No.: PCT/KR2014/007108

§ 371 Date: Feb. 2, 2016

(30) Foreign Application Priority Data
Aug. 2, 2013 (KR) 10 2013 0092173

(51) Int. Cl. F24F 6/06; F24F 13/20; F24F 13/32; B01D 47/18

(52) U.S. Cl. CPC F24F 6/06; B01D 47/18; F24F 13/20; F24F 13/32; F24F 2006/065; F24F 2006/008

(57) ABSTRACT

An air washer in which a water tank unit may be pulled out in a frontward direction is provided, in which water may be supplied by directly pulling out the water tank unit in the frontward direction, a water spilling prevention portion in the water tank unit may effectively reduce spilling of water resulting from a motion, inclination, and an impact of the water tank unit, a height difference compensation portion on a front surface portion of the water tank unit may compensate for a height difference between the water tank unit and the water tank storage portion, and a water tank locking device may prevent arbitrary separation of the water tank unit.

### TECHNICAL FIELD

Embodiments of the present invention relate to an air washer that humidifies and washes air, and more particularly, to an air washer that directly stores water to be used to humidify and wash air in a water tank in which a disk assembly is provided.

### BACKGROUND ART

In general, an air washer refers to a device that humidifies and washes air by contacting air with water. A type of the air washer may vary based on a method of contacting air with water. For example, the air washer may include an air washer that sprays water over air, an air washer that has air pass through a wet filter, and an air washer that blows air toward a disk in which a water film is formed.

Recently, active development of technology related to a disk type air washer is ongoing. The disk type air washer has advantages of less noise, small size, condensation-free humidification, and exemption from filter replacement.

Korean Patent No. 10-0757407 (hereinafter R1), entitled “Disk and disk assembly for air washer”, registered on Sep. 4, 2007, discloses a disk type air washer. In R1, a lower portion of the air washer may be formed directly by a water container, and a disk assembly may be provided in an internal portion of the water container. To refill the water container with water or wash the water container and the disk assembly, a process of separating a top case and a middle case constituting an upper portion of the air washer from the water container and assembling the separated components may be iteratively performed. Thus, tasks of refilling or washing may be overly complex and inconvenient, and the components may be damaged, lost, and incorrectly assembled during the process of separating and re-assembling the components.

Japanese Patent Application Publication No. 2006-057995 (hereinafter R2), entitled “Humidifier”, published on Mar. 2, 2006, discloses a structure in which a tank may be pulled out in a frontward direction from a humidifier body. However, R2 relates to a filter type humidifier rather than a disk type humidifier, and a structure in which a water supply tank to supply water to a water container is applied. In R2, separation of the water supply tank may be performed in advance of pulling out the water container. Thus, a task of pulling out the water container may be complex, and a possibility of decomposition or contamination of water stored in the water supply tank may increase when the water supply tank is used for a long time.

### DISCLOSURE OF INVENTION

### Technical Goals

An aspect of the present invention provides an air washer in which a water tank unit may be smoothly pulled out in a frontward direction from an air washer body, and a separate water container to supply water may be omitted.

Another aspect of the present invention provides an air washer that may prevent a motion and inclination of a water tank unit when the water tank unit is stored or pulled out.

Still another aspect of the present invention provides an air washer that may prevent spilling of water received in a water tank unit when the water tank unit is stored or pulled out.

### Technical Solutions

According to an aspect of the present invention, there is provided an air washer including an air washer body to humidify and wash air, a water tank unit including a water receiving portion, and disposed in a water tank storage portion formed in a lower portion of the air washer body to be pulled out in a frontward direction, and a water spilling prevention portion to return water spilt from the water receiving portion to an internal portion of the water receiving portion when the water tank unit sways, and formed to protrude from an upper portion of the water receiving portion toward an inner side of the water receiving portion.

In the air washer, the water tank unit may be conveniently pulled out in a frontward direction of the air washer body. Thus, water may be conveniently supplied to an internal portion of the water tank unit, and maintenance of the water tank unit may be easily performed. Since water may be supplied directly to the internal portion of the water tank unit, an installation of a separate water container to supply water to the water tank unit may be unnecessary. In addition, by forming the water spilling prevention portion in the water tank unit, the air washer may effectively prevent spilling of water from the water tank unit while the water tank unit is pulled out, stored, or transported.

The water spilling prevention portion may be formed to protrude in a form of a rib along a perimeter of the upper portion of the water receiving portion. The water spilling prevention portion may be formed to protrude in an upper portion of the water receiving portion in a form of a cross-section corresponding to at least one of a straight line and a curved line.

The air washer may further include a height difference compensation portion provided on a front surface portion of the water tank unit to prevent inclination of the water tank unit by compensating for a height difference between a bottom surface portion of the water tank storage portion and a ground when the water tank unit is pulled out or stored.

The height difference compensation portion may be formed to protrude at a set height in a lower portion of the front surface portion of the water tank unit, and the set height of the height difference compensation portion may be set to be identical to the height difference between the bottom surface portion of the water tank storage portion and the ground.

The air washer may further include a water tank locking device provided in the water tank unit and the water tank storage portion to lock the water tank unit in an internal portion of the water tank storage portion.

The water tank locking device may include a hook portion provided to protrude on a bottom surface portion of one of the water tank unit and the water tank storage portion, a stopper portion provided on a bottom surface of another of the water tank unit and the water tank storage portion to lock and fasten the hook portion when the water tank unit is stored, and an unlocking portion provided in one of the water tank unit and the air washer body to selectively cancel a locking state of the hook portion and the stopper portion when the water tank unit is pulled out.

The hook portion may be provided in a form of a projection disposed to be elastically pressed, and the stopper portion may be provided in a form of a hole or a recess into which the hook portion is to be inserted.

The unlocking portion may include an unlocking handle interoperably connected to the hook portion, and formed to be operated in a direction in which the locking state of the hook portion is cancelled when the water tank unit is pulled out, and a handle restricting member formed in the unlocking handle to restrict an operation of the unlocking handle when the water tank unit is transported.

A handle recess portion to be used to pull out the water tank unit may be formed on the front surface portion of the water tank unit. The unlocking handle may be operably provided in an internal portion of the handle recess portion. The unlocking handle may be formed to be operated in a frontward direction by a user pulling the handle recess portion in a frontward direction when pulling out the water tank unit.

The handle restricting member may be formed on one side of the unlocking handle to be operated by a user holding the handle recess portion when the water tank unit is transported. An operating direction of the handle restricting member may differ from an operating direction of the unlocking handle.

A first inclined guide portion formed to be inclined in a front-downward direction may be provided at a front end portion of a bottom surface portion of the water tank storage portion to facilitate pulling out and storing the water tank unit. A second inclined guide portion formed to be inclined in a rear-upward direction may be provided in a location corresponding to the first inclined guide portion at a rear end portion of a bottom surface portion of the water tank unit.

A first roller portion may be provided in a front portion of a bottom surface portion of the water tank storage portion to be in rolling contact with a bottom surface portion of the water tank unit. A second roller portion may be provided in a rear portion of the bottom surface portion of the water tank unit to be in rolling contact with the bottom surface portion of the water tank storage portion.

The first roller portion and the second roller portion may be disposed alternately to not face each other in the water tank storage portion and the water tank unit, respectively.

A first insertion portion into which the first roller portion is to be inserted when the water tank unit is stored may be formed in a front portion of the bottom surface portion of the water tank unit. A second insertion portion into which the second roller portion is to be inserted when the water tank unit is stored may be formed in a rear portion of the bottom surface portion of the water tank storage portion.

A transparent window may be provided on a front surface portion of the water tank unit to verify a level and a motion of water stored in the water receiving portion with naked eyes.

According to another aspect of the present invention, there is also provided an air washer including an air washer body to humidify and wash air, a water tank unit disposed to be pulled out in a frontward direction in a water tank storage portion formed in a lower portion of the air washer body, and including a water receiving portion, and a height difference compensation portion provided on a front surface portion of the water tank unit to prevent inclination of the water tank unit by compensating for a height difference between a bottom surface portion of the water tank storage portion and a ground when the water tank unit is pulled out or stored. The height difference compensation portion may be formed to protrude at a set height from a lower portion of the front surface portion of the water tank unit, and the set height of the height difference compensation portion may be set to be identical to the height difference between the bottom surface portion of the water tank storage portion and the ground.

According to still another aspect of the present invention, there is also provided an air washer including an air washer body to humidify and wash air, a water tank unit disposed to be pulled out in a frontward direction in a water tank storage portion formed in a lower portion of the air washer body, and including a water receiving portion, and a water tank locking device provided in the water tank unit and the water tank storage portion to lock the water tank unit in an internal portion of the water tank storage portion.

The water tank locking device may include a hook portion provided to protrude on a bottom surface portion of one of the water tank unit and the water tank storage portion, a stopper portion provided on a bottom surface of another of the water tank unit and the water tank storage portion to lock and fasten the hook portion when the water tank unit is stored, and an unlocking portion provided in one of the water tank unit and the air washer body to selectively cancel a locking state of the hook portion and the stopper portion when the water tank unit is pulled out. The hook portion may be provided in a form of a projection disposed to be elastically pressed, and the stopper portion may be provided in a form of a hole or a recess into which the hook portion is to be inserted. The unlocking portion may include an unlocking handle interoperably connected to the hook portion, and formed to be operated in a direction in which the locking state of the hook portion is cancelled when the water tank unit is pulled out, and a handle restricting member formed in the unlocking handle to restrict an operation of the unlocking handle when the water tank unit is transported.

### Advantageous Effects

According to an embodiment of the present invention, an air washer may be provided in a structure in which a water tank unit is conveniently pulled out in a frontward direction from a lower portion of an air washer body, whereby refilling a water receiving portion of the water tank unit with water may be conveniently performed. Thus, a water container to provide water to the water receiving portion may be omitted, whereby an increase in costs for use of the water container and an increase in a size of the air washer may be prevented, and a task to separate a water container may be omitted when the water tank unit is pulled out.

According to an embodiment of the present invention, an air washer may be provided in a structure in which a water tank unit may be pulled out in a frontward direction from a lower portion of an air washer body, whereby cleaning and maintaining the water tank unit may be conveniently performed.

According to an embodiment of the present invention, by forming a water spilling prevention portion in a water tank unit, an air washer may effectively prevent spilling of water from a water receiving portion of the water tank unit when the water tank unit is stored or pulled out.

According to an embodiment of the present invention, by forming a height difference compensation portion in a water tank unit to compensate for a height difference between a bottom surface portion of a water tank storage portion and a ground, an air washer may prevent inclination of the water tank unit when the water tank unit is stored or pulled out. Thus, the air washer may prevent spilling of water resulting from the inclination of the water tank unit when the water tank unit is stored or pulled out.

According to an embodiment of the present invention, by forming a water tank locking device in a water tank unit and a water tank storage portion, an air washer may prevent a phenomenon that the water tank unit is arbitrarily pulled out from the water tank storage portion. Thus, the air washer may prevent an issue that may occur when the water tank unit is arbitrarily pulled out from the water tank storage portion.

According to an embodiment of the present invention, an air washer may smoothly store a water tank unit in a water tank storage portion through a first inclined guide portion formed on a bottom surface portion of the water tank storage portion and a second inclined guide portion formed on a bottom surface portion of the water tank unit. The water tank unit may be smoothly stored in or pulled out from the water tank storage portion through the first inclined guide portion and the second inclined guide portion. Thus, the air washer may reduce a motion, inclination, or an impact of the water tank unit and prevent spilling of water from the water tank unit when the water tank unit is stored or pulled out.

According to an embodiment of the present invention, an air washer may include a first roller portion and a second roller portion on a bottom surface portion of a water tank storage portion and a bottom surface portion of a water tank unit, respectively, thereby smoothly transporting the water tank unit in an internal portion of the water tank storage portion when the water tank unit is stored or pulled out. Thus, the water tank unit may be gently moved in the internal portion of the water tank storage portion with less power, whereby the air washer may prevent a motion, inclination, or an impact of the water tank unit occurring when the water tank unit is moved.

### BRIEF DESCRIPTION OF DRAWINGS

FIG. 1 is a perspective view illustrating an air washer according to an embodiment of the present invention.

FIG. 2 is a perspective view illustrating a water tank unit pulled out in a frontward direction from the air washer of FIG. 1.

FIG. 3 is a right side view illustrating the air washer of FIG. 2.

FIG. 4 is a cross-sectional view illustrating an example of a water tank unit cut along a line A-A of FIG. 3.

FIG. 5 is a cross-sectional view illustrating another example of the water tank unit of FIG. 4.

FIG. 6 is a perspective view illustrating an air washer body of FIG. 2.

FIG. 7 is a perspective view illustrating the water tank unit of FIG. 2.

FIG. 8 is a plan view of a bottom surface portion of a water tank storage portion of FIG. 6.

FIG. 9 is a view illustrating an operating state of a water tank locking device when a water tank unit of FIG. 8 is pulled out.

FIG. 10 is a view illustrating an operating state of a water tank locking device when the water tank unit of FIG. 8 is transported.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

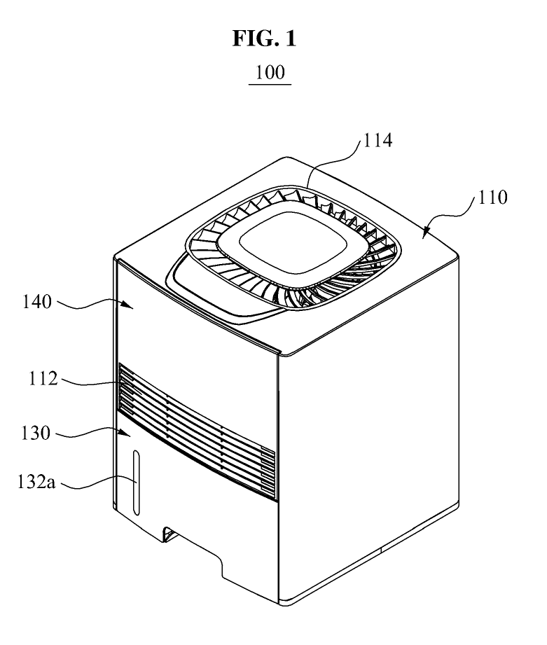

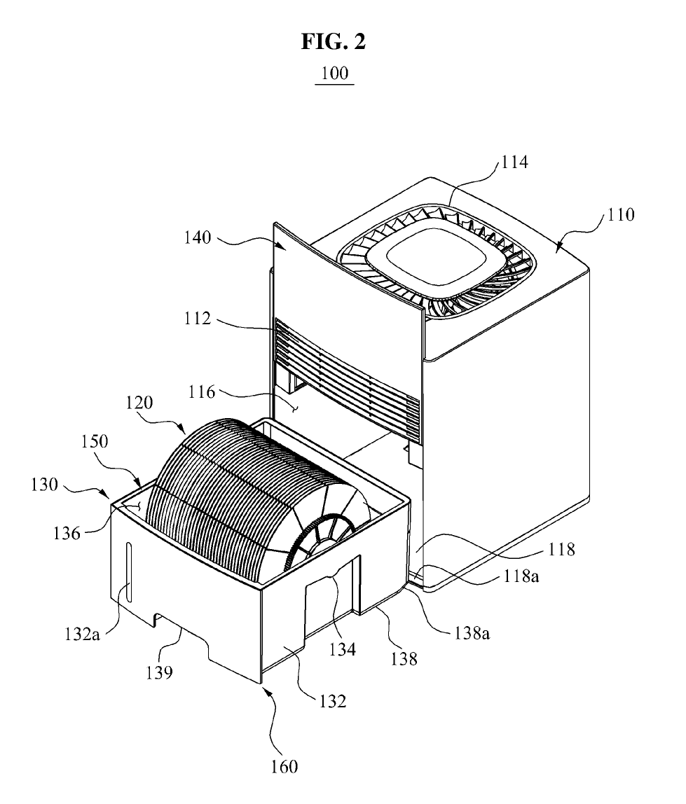

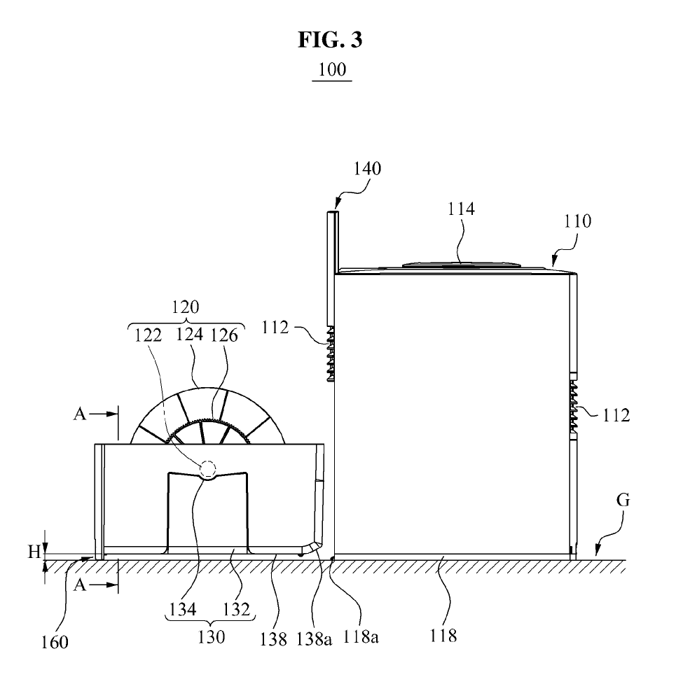

FIG. 1 is a perspective view illustrating an air washer 100 according to an embodiment of the present invention. FIG. 2 is a perspective view illustrating a water tank unit 130 pulled out in a frontward direction from the air washer 100 of FIG. 1. FIG. 3 is a right side view illustrating the air washer 100 of FIG. 2.

Referring to FIGS. 1 through 3, the air washer 100 may include an air washer body 110, an air blowing unit (not shown), a disk assembly 120, and the water tank unit 130.

The air blowing unit may be configured to draw external air into an internal portion of the air washer 100, and exhaust air processed by the air washer 100 out of the air washer 100. The air blowing unit may include a blower to forcibly blow air, and a shroud disposed in a vicinity of the blower.

The air washer body 110 may be formed to have an appearance similar to a box. The air blowing unit, the disk assembly 120, and the water tank unit 130 may be received in the air washer body 110.

The air washer body 110 may include an air inlet 112 and an air outlet 114. External air may be drawn through the air inlet 112 into the air washer body 110. The air inlet 112 may be formed on both a rear surface portion of the air washer body 110 and a front panel 140. Humidified and washed air may be exhausted through the air outlet 114 out of the air washer body 110. The air outlet 114 may be formed on a top surface portion of the air washer body 110.

The air blowing unit may be disposed on an air flow path formed between the air inlet 112 and the air outlet 114. Hereinafter, the air blowing unit will be described to be disposed below the air outlet 114. However, an embodiment of the present invention is not limited thereto. The air blowing unit may be provided at various locations depending on design conditions and situations.

A water tank storage portion 116 opening in a frontward direction may be formed in a lower portion of the air washer body 110. The water tank storage portion 116 is a space to store the water tank unit 130. The water tank unit 130 may be disposed to be slidingly moved in the water tank storage portion 116.

Referring to FIGS. 2 and 3, the disk assembly 120 may be configured to humidify and wash the air drawn in by the air blowing unit. Thus, the disk assembly 120 may be disposed on the air flow path between the air inlet 112 and the air outlet 114.

The disk assembly 120 may include a disk shaft 122, a disk plate 124, and a driving plate 126.

The disk shaft 122 may be disposed to be rotatable on a shaft support portion 134 of the water tank unit 130. The disk plate 124 and the driving plate 126 may be mounted and fastened on the disk shaft 122. Thus, the disk plate 124 and the driving plate 126 may rotate along with the disk shaft 122.

A plurality of disk plates 124 may be disposed to be spaced from one another other on the disk shaft 122. Lower portions of the disk plates 124 may be sunk under water in the water tank unit 130. When the disk plates 124 rotate along with the disk shaft 122, water films may be formed on surfaces of the disk plates 124. Humidification and washing may be performed through a process of contacting the air drawn in through the air inlet 112 with the water films of the disk plates 124.

An external driving power may be input into the driving plate 126. A gear portion into which the driving power is input may be formed along an outer circumference of the driving plate 126. The driving plate 126 may be disposed next to the disk plates 124.

The water tank unit 130 may be configured to store water to be used in the air washer 100. As described above, the disk assembly 120 may be disposed to be rotatable in an internal portion of the water tank unit 130. The water tank unit 130 may be stored in the water tank storage portion 116, and pulled out in the frontward direction of the air washer body 110.

The water tank unit 130 may include a water tank body 132 and the shaft support portion 134.

The water tank body 132 is a member in a shape of a box in which water is stored. A water receiving portion 136 may be formed in an internal portion of the water tank body 132 to receive water therein. The water tank body 132 may be disposed in the internal portion of the water tank storage 116 to be pulled out in a frontward direction.

A transparent window 132a may be formed on a front surface portion of the water tank body 132 to verify a level and a motion of water stored in the water receiving portion 136. Thus, when the air washer 100 is used, a point in time at which water is to be replenished may be conveniently verified with naked eyes through the transparent window 132a. In addition, a motion of the stored water may be accurately verified through the transparent window 132a when the water tank unit 130 is pulled out, stored, or transported.

The shaft support portion 134 is a member to support both end portions of the disk shaft 122 to be rotatable. The shaft support portion 134 may be formed on both sides of the water receiving portion 136. Thus, the disk assembly 120 may be disposed to be rotatable in the internal portion of the water receiving portion 136.

The air washer 100 may further include the front panel 140 provided to be movable in a vertical direction on the front surface portion of the air washer body 110. As described above, the air inlet 112 may be formed on the front panel 140.

When the water tank unit 130 is completely stored in the water tank storage portion 116, the front panel 140 may be moved in a downward direction to form a front surface of the air washer 100. Thus, the front panel 140 may completely shield the water tank storage portion 116, whereby esthetics of an appearance of the air washer 100 may increase, and an inflow of an external foreign substance through the water tank storage portion 116 into the internal portion of the air washer 100 may be prevented.

When the water tank unit 130 is pulled out from the water tank storage portion 116, the front panel 140 may be moved in an upward direction to prevent a collision with the disk assembly 120. Thus, the water tank unit 130 and the disk assembly 120 may be smoothly pulled out in a frontward direction of the water tank storage portion 116 without interference by the front panel 140.

A first inclined guide portion 118a may be provided at a front end portion of a bottom surface portion 118 of the water tank storage portion 116, and a second inclined guide portion 138a may be provided at a rear end portion of a bottom surface portion 138 of the water tank unit 130. The first inclined guide portion 118a and the second inclined guide portion 138a may be formed at face-to-face locations of the water tank storage portion 116 and the water tank unit 130.

The first inclined guide portion 118a may be formed to be inclined in a front-downward direction, and the second inclined guide portion 138a may be formed to be inclined in a rear-upward direction. Thus, the water tank unit 130 may be easily stored in the water tank storage portion 116, and smoothly pulled out from the water tank storage portion 116.

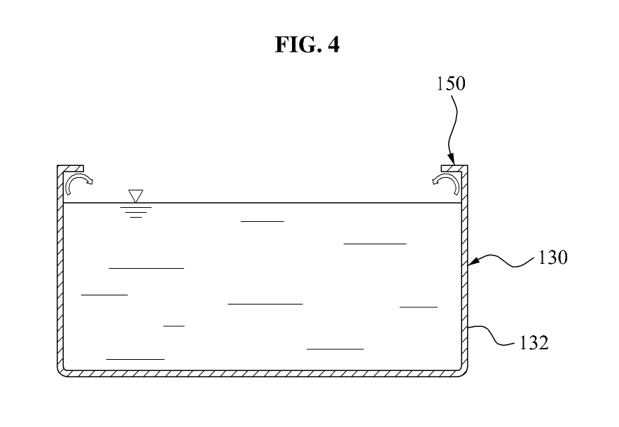

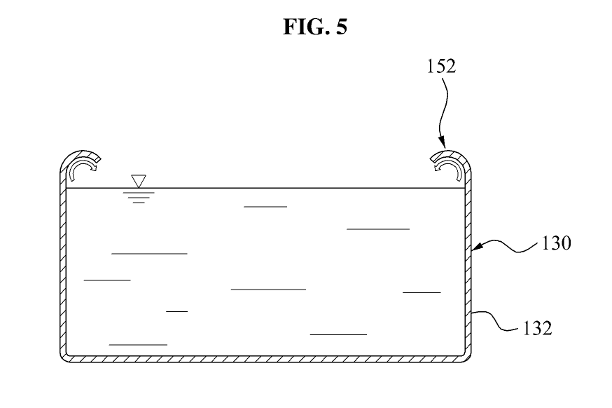

FIG. 4 is a cross-sectional view illustrating an example of the water tank unit 130 cut along a line A-A of FIG. 3. FIG. 5 is a cross-sectional view illustrating another example of the water tank unit 130 of FIG. 4.

Referring to FIGS. 2, 4, and 5, the air washer 100 may further include a water spilling prevention portion 150 or 152 to return water spilt from the water receiving portion 136 to an internal portion of the water receiving portion 136 when the water tank unit 130 sways. Thus, the air washer 100 may effectively prevent instant spilling of water from the water tank unit 130 when the water tank unit 130 sways while being pulled out, stored, or transported.

The water spilling prevention portion 150 or 152 may be formed to protrude from an upper portion of the water receiving portion 136 toward an inner side of the water receiving portion 136. For example, the water spilling prevention portion 150 or 152 may be formed to protrude in a form of a rib along a perimeter of the upper portion of the water receiving portion 136.

The water spilling prevention portion 150 or 152 may be formed to protrude in the upper portion of the water receiving portion 136 in a form of a cross-section corresponding to a straight line or a curved line. FIG. 4 illustrates the water spilling prevention portion 150 formed to have a cross-section corresponding to a straight line, and FIG. 5 illustrates the water spilling prevention portion 152 formed to have a cross-section corresponding to a curved line. Hereinafter, for ease of description, the water spilling prevention portion 150 of FIG. 4 may be formed in the water tank unit 130.

Accordingly, when the water stored in the water receiving portion 136 is temporarily spilt due to a motion of the water tank unit 130, the spilt water may be guided along the water spilling prevention portion 150 into the internal portion of the water receiving portion 136.

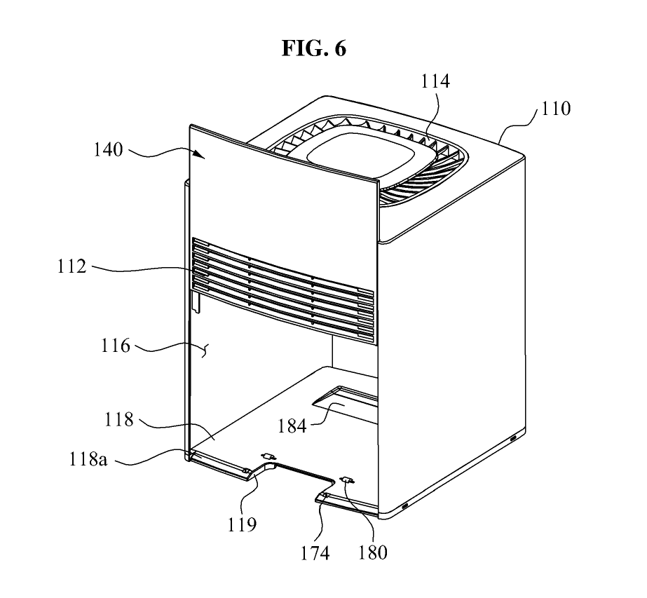

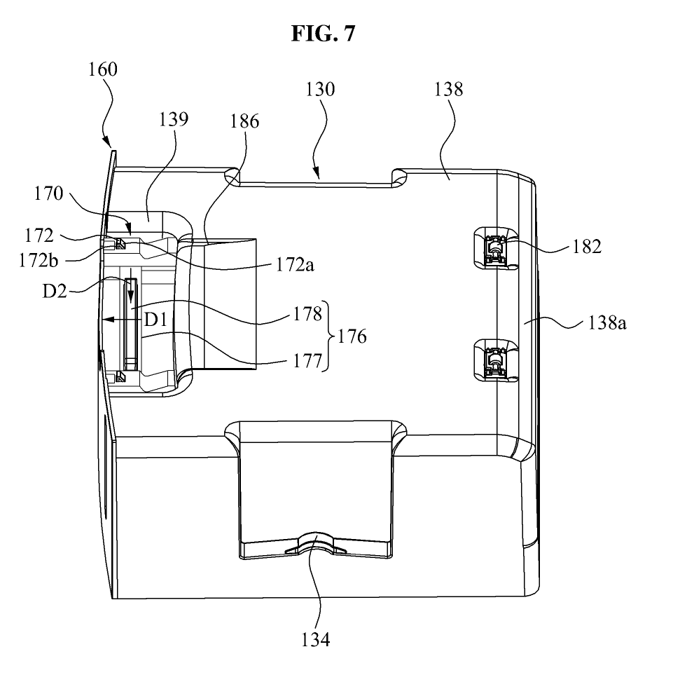

FIG. 6 is a perspective view illustrating the air washer body 110 of FIG. 2, and FIG. 7 is a perspective view illustrating the water tank unit 130 of FIG. 2.

Referring to FIGS. 2, 3, 6, and 7, the air washer 100 may further include a height difference compensation portion 160 to compensate for a height difference H between the bottom surface portion 118 of the water tank storage portion 116 and a ground G when the water tank unit 130 is pulled out or stored.

The term “ground” refers to a surface of a place in which the air washer 100 is set up. When the air washer 100 is set up in a room, a floor of the room may correspond to the ground G. When the air washer 100 is set up on a table, a top surface of the table may correspond to the ground G.

The bottom surface portion 118 of the water tank storage portion 116 may be formed to have a predetermined thickness. Due to the thickness, the bottom surface portion 118 of the water tank storage portion 116 may be disposed to be higher than the ground G. When the bottom surface portion 118 of the water tank storage portion 116 is disposed to be higher than the ground G, the height difference H between the bottom surface portion 118 of the water tank storage portion 116 and the ground G may cause the water tank unit 130 to be disposed to be inclined in a frontward direction when the water tank unit 130 is pulled out or stored. When the water tank unit 130 is inclined, the water in the water receiving portion 136 may be spilt from the water receiving portion 136.

The height difference compensation portion 160 may be formed to protrude at a set height H in a lower portion of the front surface portion of the water tank unit 130 to prevent inclination of the water tank unit 130. The set height H of the height difference compensation portion 160 may be set to be identical to the height difference H between the bottom surface portion 118 of the water tank storage portion 116 and the ground G.

For example, the height difference compensation portion 160 may be formed in a structure in which the front surface portion of the water tank unit 130 is extended in a downward direction by the set height H. The height difference compensation portion 160 and the front surface portion of the water tank unit 130 may be integrally formed. However, an embodiment of the present invention is not limited thereto. A shape of the height difference compensation portion 160 may vary depending on design conditions and situations. In an example, the height difference compensation portion 160 may be formed in the lower portion of the front surface portion of the water tank unit 130 to protrude in a form of a projection.

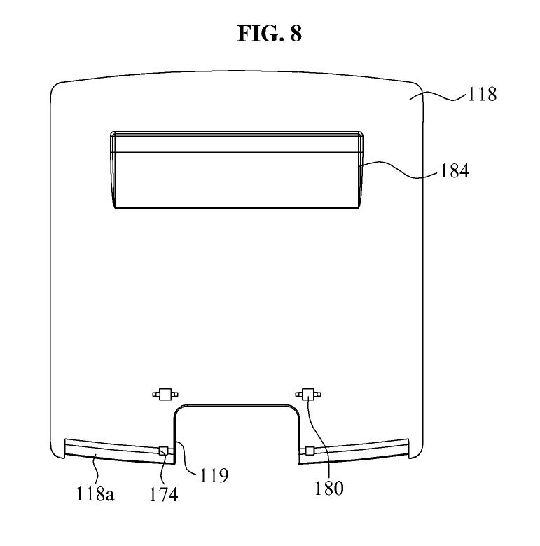

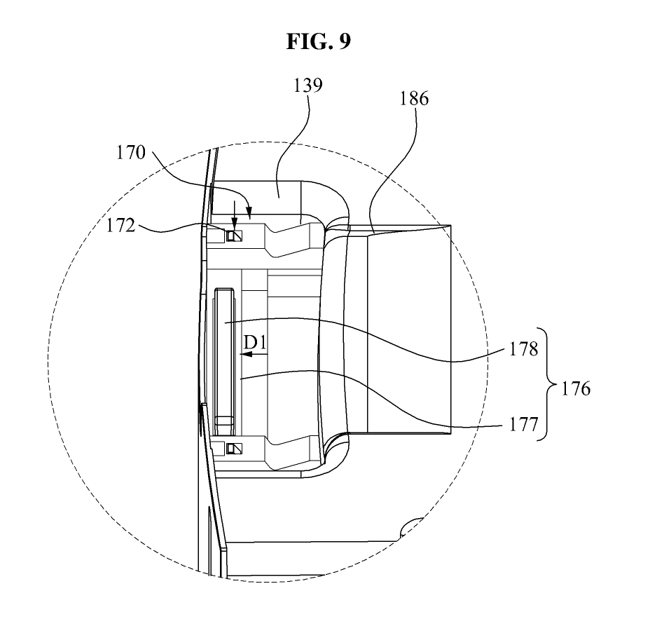

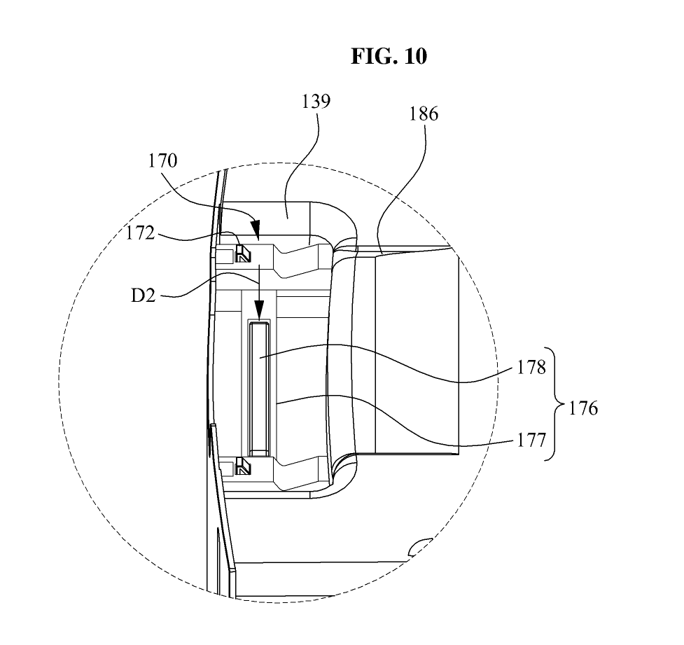

FIG. 8 is a plan view of the bottom surface portion 118 of the water tank storage portion 116 of FIG. 6. FIG. 9 is a view illustrating an operating state of a water tank locking device 170 when the water tank unit 130 of FIG. 8 is pulled out. FIG. 10 is a view illustrating an operating state of the water tank locking device 170 when the water tank unit 130 of FIG. 8 is transported.

Referring to FIGS. 6 through 10, the air washer 100 may further include the water tank locking device 170 to lock the water tank unit 130 in an internal portion of the water tank storage portion 116.

The water tank locking device 170 may be provided in the water tank unit 130 and the water tank storage portion 116 to selectively lock the water tank unit 130 in the water tank storage portion 116. Thus, the water tank unit 130 may not be arbitrarily separated from the water tank storage portion despite an external impact or oscillation.

For example, the water tank locking device 170 may include a hook portion 172, a stopper portion 174, and an unlocking portion 176. The hook portion 172 may be provided to protrude on a bottom surface portion of one of the water tank unit 130 and the water tank storage portion 116. The stopper portion 174 may be provided on a bottom surface of another of the water tank unit 130 and the water tank storage portion 116 to lock and fasten the hook portion 172 when the water tank unit 130 is stored. The unlocking portion 176 may be provided in one of the water tank unit 130 and the air washer body 110 to selectively cancel a locking state of the hook portion 172 and the stopper portion 174 when the water tank unit 130 is pulled out. Hereinafter, the hook portion 172 may be formed on the bottom surface portion 138 of the water tank unit 130, the stopper portion 174 may be formed on the bottom surface 118 of the water tank storage portion 116, and the unlocking portion 176 may be formed in the water tank unit 130 to be interoperable with the hook portion 172. However, an embodiment of the present invention is not limited thereto. A configuration of the water tank locking device 170 may vary depending on design conditions and situations.

The hook portion 172 may be provided in a form of a projection disposed to be elastically pressed. An inclined surface 172a may be formed in a rear portion of an edge of the hook portion 172 to be inclined in a front-downward direction. A perpendicular surface 172b may be formed in a front portion of the edge of the hook portion 172 to be perpendicular in a vertical direction. Thus, when the water tank unit 130 is stored, the hook portion 172 may be elastically pressed to smoothly run over the bottom surface portion 118 of the water tank storage portion 116. When the water tank unit 130 is pulled out, the hook portion 172 may be elastically restored to be definitely locked and restricted by the stopper portion 174.

The stopper portion 174 may be provided in a form of a hole or a recess having a size enabling an insertion of the hook portion 172 thereinto. Hereinafter, the stopper portion 174 may be provided in a form of a hole penetrating through the bottom surface 118 of the water tank storage portion 116. However, an embodiment of the present invention is not limited thereto. Various structures to lock the hook portion 172 may be applicable.

The unlocking portion 176 may include an unlocking handle 177 and a handle restricting member 178.

The unlocking handle 177 may be interoperably connected to one side of the hook portion 172. The unlocking handle 177 may be formed to be operated in a direction in which a lock state of the hook portion 172 is cancelled when the water tank unit 130 is pulled out. However, a connection structure between the unlocking handle 177 and the hook portion 172 is not specifically limited. Various connection structures to separate the hook portion 172 from the stopper portion 174 in response to an operation of the unlocking handle 177 may be applicable.

The handle restricting member 178 may be provided on one side of the unlocking handle 177. The handle restricting member 178 may be formed to restrict an operation of the unlocking handle 177 when the water tank unit 130 is transported. However, a connection structure between the handle restricting member 178 and the unlocking handle 177 is not specifically limited. Various connection structures to restrict the operation of the unlocking handle 177 in response to an operation of the handle restricting member 178 may be applicable.

A handle recess portion 139 to be used to pull out the water tank unit 130 may be formed on the front surface portion of the water tank unit 130. In addition, a handle recess 119 may be formed at a location corresponding to the handle recess portion 139 in a front portion of the bottom surface portion 118 of the air washer body 110. Thus, the water tank unit 130 may be conveniently pulled out in a frontward direction of the water tank storage portion 116 by conveniently putting a hand in the handle recess portion 139 through the handle recess 119 and pulling the handle recess portion 139 in the frontward direction.

The unlocking handle 177 may be operably provided in an internal portion of the handle recess portion 139. For example, the unlocking handle 177 may be operated and moved in a frontward direction by a hand of a user pulling the handle recess portion 139 in a frontward direction to pull out the water tank unit 130. When the unlocking handle 177 is operated and moved in the frontward direction, the hook portion 172 interoperating with the unlocking handle 177 may be forcibly pressed to be released from the stopper portion 174, whereby a locking state of the water tank unit 130 may be cancelled.

The handle restricting member 178 may be operably provided in the unlocking handle 177. As illustrated in FIGS. 7, 9, and 10, an operating direction D2 of the handle restricting member 178 may differ from an operating direction D1 of the unlocking handle 177. For example, the operating direction D1 of the unlocking handle 177 may be set to be a forward and backward direction identical to a travel direction of the water tank unit 130 when the water tank unit 130 is stored or pulled out. The operating direction D2 of the handle restricting member 178 may be set to be a vertical direction in which the water tank unit 130 is to be lifted when the water tank unit 130 is transported. When the operating direction D2 of the handle restricting member 178 differs from the operating direction D1 of the unlocking handle 177, a phenomenon that the handle restricting member 178 is arbitrarily operated in response to the operation of the unlocking handle 177 and a phenomenon that the unlocking handle 177 is arbitrarily operated in response to the operation of the handle restricting member 178 may be prevented in advance.

Hereinafter, when the unlocking handle 177 is moved in a frontward direction, the hook portion 172 may be pressed and a locking state of the water tank unit 130 may be cancelled. When the handle restricting member 178 is pressed in an upward direction, the operation of the unlocking handle 177 may be restricted. Thus, the operating direction D1 of the unlocking handle 177 may be set to be a frontward direction which is identical to a direction in which the water tank unit 130 is pulled out. The operating direction D2 of the handle restricting member 178 may be set to be an upward direction which is identical to a direction in which the water tank unit 130 is lifted. In this example, the unlocking handle 177 may be elastically supported in a rearward direction, and the handle restricting member 178 may be elastically supported in a downward direction in which the handle restricting member 178 protrudes.

Referring to FIGS. 6 through 10, a first roller portion 180 may be provided in a front portion of the bottom surface portion 118 of the water tank storage portion 116 to be in rolling contact with the bottom surface portion 138 of the water tank unit 130. A second roller portion 182 may be provided in a rear portion of the bottom surface portion 138 of the water tank unit 130 to be in rolling contact with the bottom surface portion 118 of the water tank storage portion 116. Types and installation structures of the first roller portion 180 and the second roller portion 182 are not specifically limited, and may vary depending on design conditions and situations of the air washer 100.

The first roller portion 180 and the second roller portion 182 may be disposed alternately to not face each other in the water tank storage portion 116 and the water tank unit 130, respectively. For example, first roller portions 180 may be disposed on a left side and a right side of the handle recess 119 formed in the front portion of the bottom surface portion 118 of the water tank storage portion 116, and second roller portions 182 may be disposed at locations further separated in a lateral direction than the first roller portions 180 in the rear portion of the bottom surface portion 138 of the water tank unit 130. Accordingly, the first roller portions 180 and the second roller portions 182 may not collide with each other when the water tank unit 130 is stored and pulled out and thus, a motion of the water tank unit 130 caused by a collision between the first roller portions 180 and the second roller portions 182 may be prevented.

Referring to FIGS. 6 through 10, a first insertion portion 186 into which the first roller portion 180 is to be inserted when the water tank unit 130 is stored may be formed in the front portion of the bottom surface portion 138 of the water tank unit 130. A second insertion portion 184 into which the second roller portion 182 is to be inserted when the water tank unit 130 is stored may be formed in the rear portion of the bottom surface portion 118 of the water tank storage portion 116. The first insertion portion 186 and the second insertion portion 184 may be provided in a form of recesses or holes into which the first roller portion 180 and the second roller portion 182 may be inserted.

The first insertion portion 186 and the second insertion portion 184 may be formed at locations at which the first roller portion 180 and the second roller portion 182 are to be disposed when the water tank unit 130 is stored. Thus, the first insertion portion 186 and the second insertion portion 184 may eliminate predetermined gaps generated by the first roller portion 180 and the second roller portion 182 between the bottom surface 138 of the water tank unit 130 and the bottom surface 118 of the water tank storage portion 116. In addition, the first insertion portion 186 and the second insertion portion 184 may intuitively verify a correct location at which the water tank unit 130 is to be stored through an insertion motion of the first roller portion 180 and the second roller portion 182.

An operation and application effects of the air washer 100 will be described.

When the air washer 100 is used for a long time, there may be a possibility of water shortage or water contamination. When the air washer 100 is used for a long time, regular cleaning or maintenance of the water tank unit 130 and the disk assembly 120 may be required.

To refill the water tank unit 130 with water, replace water, clean and maintain the water tank unit 130, or clean and maintain the disk assembly 120, pulling out of the water tank unit 130 and the disk assembly 120 may be required.

An operation of the air washer 100 may be completely terminated. The handle recess portion 139 of the water tank unit 130 may be hold through the handle recess 119 of the water tank storage portion 116.

The water tank unit 130 may be pulled out in a frontward direction while pulling the unlocking handle 177 of the unlocking portion 176 in a frontward direction along with the handle recess portion 139. In this example, the handle restricting member 178 of the unlocking portion 176 may not be pressed.

When the unlocking handle 177 is moved in the frontward direction, the hook portion 172 of the water tank unit 130 may be separated from the stopper portion 174 of the water tank storage portion 116 and the locking state of the water tank unit 130 may be cancelled. Thus, the water tank unit 130 may be ready to be pulled out in the frontward direction from the water tank storage portion 116.

The water tank unit 130 may be pulled out in the frontward direction from the water tank storage portion 116 along with the disk assembly 120. In the interim, the front panel 140 may be opened automatically or manually.

When the water tank unit 130 and the disk assembly 120 are completely pulled out from the air washer body 110, the water tank unit 130 and the disk assembly 120 may be cleaned or maintained. Also, the water stored in the water receiving portion 136 of the water tank unit 130 may be drained and the water receiving portion 136 of the water tank unit 130 may be refilled with clean water.

The disk assembly 120 may be disposed in the water receiving portion 136 of the water tank unit 130, and the water tank unit 130 may be pushed into the water tank storage portion 116 of the air washer body 110.

In this example, the hook portion 172 of the water tank unit 130 may be slidingly transported while being pressed along the bottom surface portion 118 of the water tank storage portion 116. When the water tank unit 130 is completely stored in the water tank storage portion 116, the hook portion 172 may elastically protrude on the bottom surface portion 138 of the water tank unit 130 toward the stopper portion 174 of the water tank storage portion 116.

When the hook portion 174 is inserted into an internal portion of the stopper portion 174, the water tank unit 130 may be locked and fastened in the water tank storage portion 116 by the hook portion 172 and the stopper portion 174.

When the water tank unit 130 is pulled out from the water tank storage portion 116, stored in the water tank storage portion 116, or transported to a predetermined location, the water tank unit 130 may sway or be inclined or an external impact may be applied to the water tank unit 130. Accordingly, water in the water tank unit 130 may be temporarily spilt out of the water receiving portion 136. However, the spilt water may be returned to an internal portion of the water receiving portion 136 along the water spilling prevention portion 150 formed in an upper portion of the water receiving portion 136. Although the water tank unit 130 is pulled out, stored, and transported, a probability that the water in the water tank unit 130 may be spilt may be reduced. Thus, a usability and a product reliability of the air washer 100 may be enhanced.

When the water tank unit 130 is pulled out from or stored in the water tank storage portion 116, there may be the height difference H since the bottom surface portion 118 of the water tank storage portion 116 is disposed at a higher location than the ground G. However, such a height difference H may be compensated for by the height difference compensation portion 160 formed on the front surface portion of the water tank unit 130. Thus, although the front surface portion of the water tank unit 130 is disposed on the ground G, and the rear surface portion of the water tank unit 130 is disposed on the bottom surface portion 118 of the water tank storage portion 116, the water tank unit 130 may be horizontally pulled out from or stored in the water tank storage portion 116 by the height difference compensation portion 160.

In addition, the water tank unit 130 and the water tank storage portion 116 may be relatively moved while being in rolling contact with each other by the first roller portion 180 provided on the bottom surface portion 118 of the water tank storage portion 116 and the second roller portion 182 provided on the bottom surface portion 138 of the water tank unit 130. Thus, a frictional resistance applied between the bottom surface portion 138 of the water tank unit 130 and the bottom surface portion 118 of the water tank storage portion 116 when the water tank unit 130 is pulled out or stored may be greatly reduced, and the water tank unit 130 may be more gently and smoothly pulled out or stored, a motion, inclination, or an impact may be reduced.

Further, through the first inclined guide portion 118a formed at the front end portion of the bottom surface portion 118 of the water tank storage portion 116 and the second inclined guide portion 138a formed at the rear end portion of the bottom surface portion 138 of the water tank unit 130, the water tank unit 130 may be easily inserted and stored into the water tank storage portion 116 and stably pulled out from the water tank storage portion 116.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An air washer, comprising:
an air washer body to humidify and wash air;
a water tank unit comprising a water receiving portion, and disposed in a water tank storage portion formed in a lower portion of the air washer body to be pulled out in a frontward direction; and
a water spilling prevention portion to return water spilt from the water receiving portion to an internal portion of the water receiving portion when the water tank unit sways, and formed to protrude from an upper portion of the water receiving portion toward an inner side of the water receiving portion.

2. The air washer of claim 1, wherein the water spilling prevention portion is formed to protrude in a form of a rib along a perimeter of the upper portion of the water receiving portion.

3. The air washer of claim 1, wherein the water spilling prevention portion is formed to protrude in an upper portion of the water receiving portion in a form of a cross-section corresponding to at least one of a straight line and a curved line.

4. The air washer of claim 1, further comprising:
a height difference compensation portion provided on a front surface portion of the water tank unit to prevent inclination of the water tank unit by compensating for a height difference between a bottom surface portion of the water tank storage portion and a ground when the water tank unit is pulled out or stored.

5. The air washer of claim 4, wherein the height difference compensation portion is formed to protrude at a set height in a lower portion of the front surface portion of the water tank unit, and
the set height of the height difference compensation portion is set to be identical to the height difference between the bottom surface portion of the water tank storage portion and the ground.

6. The air washer of claim 1, further comprising:
a water tank locking device provided in the water tank unit and the water tank storage portion to lock the water tank unit in an internal portion of the water tank storage portion.

7. The air washer of claim 6, wherein the water tank locking device comprises:
a hook portion provided to protrude on a bottom surface portion of one of the water tank unit and the water tank storage portion;
a stopper portion provided on a bottom surface of another of the water tank unit and the water tank storage portion to lock and fasten the hook portion when the water tank unit is stored; and
an unlocking portion provided in one of the water tank unit and the air washer body to selectively cancel a locking state of the hook portion and the stopper portion when the water tank unit is pulled out.

8. The air washer of claim 7, wherein the hook portion is provided in a form of a projection disposed to be elastically pressed, and
the stopper portion is provided in a form of a hole or a recess into which the hook portion is to be inserted.

9. The air washer of claim 7, wherein the unlocking portion comprises:
an unlocking handle interoperably connected to the hook portion, and formed to be operated in a direction in which the locking state of the hook portion is cancelled when the water tank unit is pulled out; and
a handle restricting member formed in the unlocking handle to restrict an operation of the unlocking handle when the water tank unit is transported.

10. The air washer of claim 9, wherein a handle recess portion to be used to pull out the water tank unit is formed on the front surface portion of the water tank unit,
the unlocking handle is operably provided in an internal portion of the handle recess portion, and
the unlocking handle is formed to be operated in a frontward direction by a user pulling the handle recess portion in a frontward direction when pulling out the water tank unit.

11. The air washer of claim 10, wherein the handle restricting member is formed on one side of the unlocking handle to be operated by a user holding the handle recess portion when the water tank unit is transported, and
an operating direction of the handle restricting member differs from an operating direction of the unlocking handle.

12. The air washer of claim 1, wherein a first inclined guide portion formed to be inclined in a front-downward direction is provided at a front end portion of a bottom surface portion of the water tank storage portion to facilitate pulling out and storing the water tank unit, and
a second inclined guide portion formed to be inclined in a rear-upward direction is provided in a location corresponding to the first inclined guide portion at a rear end portion of a bottom surface portion of the water tank unit.

13. The air washer of claim 1, wherein a first roller portion is provided in a front portion of a bottom surface portion of the water tank storage portion to be in rolling contact with a bottom surface portion of the water tank unit, and
a second roller portion is provided in a rear portion of the bottom surface portion of the water tank unit to be in rolling contact with the bottom surface portion of the water tank storage portion.

14. The air washer of claim 13, wherein the first roller portion and the second roller portion are disposed alternately to not face each other in the water tank storage portion and the water tank unit, respectively.

15. The air washer of claim 13, wherein a first insertion portion into which the first roller portion is to be inserted when the water tank unit is stored is formed in a front portion of the bottom surface portion of the water tank unit, and
a second insertion portion into which the second roller portion is to be inserted when the water tank unit is stored is formed in a rear portion of the bottom surface portion of the water tank storage portion.

16. The air washer of claim 1, wherein a transparent window is provided on a front surface portion of the water tank unit to verify a level and a motion of water stored in the water receiving portion with naked eyes.

17. An air washer, comprising:
an air washer body to humidify and wash air;
a water tank unit disposed to be pulled out in a frontward direction in a water tank storage portion formed in a lower portion of the air washer body, and comprising a water receiving portion; and
a height difference compensation portion provided on a front surface portion of the water tank unit to prevent inclination of the water tank unit by compensating for a height difference between a bottom surface portion of the water tank storage portion and a ground when the water tank unit is pulled out or stored.

18. The air washer of claim 17, wherein the height difference compensation portion is formed to protrude at a set height from a lower portion of the front surface portion of the water tank unit, and
the set height of the height difference compensation portion is set to be identical to the height difference between the bottom surface portion of the water tank storage portion and the ground.

19. An air washer, comprising:
an air washer body to humidify and wash air;
a water tank unit disposed to be pulled out in a frontward direction in a water tank storage portion formed in a lower portion of the air washer body, and comprising a water receiving portion; and
a water tank locking device provided in the water tank unit and the water tank storage portion to lock the water tank unit in an internal portion of the water tank storage portion.

20. The air washer of claim 19, wherein the water tank locking device comprises:
a hook portion provided to protrude on a bottom surface portion of one of the water tank unit and the water tank storage portion;
a stopper portion provided on a bottom surface of another of the water tank unit and the water tank storage portion to lock and fasten the hook portion when the water tank unit is stored; and
an unlocking portion provided in one of the water tank unit and the air washer body to selectively cancel a locking state of the hook portion and the stopper portion when the water tank unit is pulled out.

21. The air washer of claim 20, wherein the hook portion is provided in a form of a projection disposed to be elastically pressed, and
the stopper portion is provided in a form of a hole or a recess into which the hook portion is to be inserted.

22. The air washer of claim 20, wherein the unlocking portion comprises:
an unlocking handle interoperably connected to the hook portion, and formed to be operated in a direction in which the locking state of the hook portion is cancelled when the water tank unit is pulled out; and
a handle restricting member formed in the unlocking handle to restrict an operation of the unlocking handle when the water tank unit is transported.
